(19) United States
(12) Patent Application Publication
(10) Pub. No.: US 2010/0219656 A1
(43) Pub. Date: Sep. 2, 2010

(54) Cabling arrangement for tarping systems

(76) Inventors: Lynn Chenowth, Rodeo, NM (US); Rory H. Chenowth, Ramona, CA (US)

Correspondence Address: CHARMASSON, BUCHACA & LEACH, LLP, 2635 Camino Del Rio South, Suite 102, SAN DIEGO, CA, 92108, US

(21) Appl. No.: 12/396,419

(22) Filed: Mar. 2, 2009

(51) Int. Cl. B60J 11/00

(52) U.S. Cl. 296/98

(57) ABSTRACT

A tarp cover for a cargo compartment is wound up on a rotating drum translatably spanning the compartment. The tarp is unfurled from the drum by a motor-driven cable and spool assembly pulling the leading edge of the tarp. The tarp retracting mechanism comprises a coil spring coaxially mounted on an axle held within the drum. A single cable running through a series of pulleys and through the scroll's leading edge pull-rod automatically equalizes tension on both ends of the pull-rod. A central vaulted region of the tarp engages the drum allowing free edges to closely bear against lateral edges of the compartment. Tarp tautness is enhance by an over-the-edge lever action imparted by the oblong pull-rod sliders. Each pull-rod pulley has two degrees of rotation freedom.

### FIELD OF THE INVENTION

The instant invention relates to scroll winding mechanisms such as those used for retractable tarp covers commonly used to temporarily cover over the open-topped cargo compartments of vehicles.

### BACKGROUND

Vehicle cargo compartments for transporting bulk materials such as dirt, sand, grass clippings and the like are often covered with a tarpaulin or tarp during travel in order to avoid blowing out part of the load and thus creating a hazardous condition on the highway or contaminating the surroundings, or to prevent the load from getting wet. In many applications it is important to form a tight, wind and water resistant seal between the tarp and the compartment walls.

The tarp cover is commonly wound upon a cylindrical drum installed along an edge of the compartment. The leading edge of the tarp is typically pulled over the cargo load by a pair of swinging booms mounted to the lateral edges of the compartment. Such a device is disclosed in U.S. Pat. No. 5,058,956 Goodwin, Sr. incorporated herein by reference. The booms are usually driven by a hydraulic cylinder or an electrical motor. The tarp is allowed to retract automatically under the pull of a torsional, coil or spiral spring mounted coaxially with the axle of the drum.

In some other embodiments as illustrated in U.S. Pat. No. 5,354,113 Petterson, incorporated herein by reference, the leading edge of the tarp is pulled by a motor or hand-crank driven cable, or chain and pulley mechanism.

A problem inherent to the above-described tarp take-up and rewinding mechanism is that the tension of the rewinding spring tends to increase considerably as the tarp is pulled over a long distance. This may require the use of more powerful driving motors or sturdier components. Further, overwinding of a torsional coil spring can cause it to corkscrew, which in turn can cause differential stresses, leading to metal fatigue and a reduction in spring life. Such corkscrewing can also cause the spring to scrape against the drum internal walls increasing drag and wear. Combating such problems by increasing the strength of winding mechanisms lead to unwanted increases in weight and bulkiness.

For oblong, open-topped containers it is often preferable to deploy from long edge to long edge so that the travel distance of the tarp's leading edge is minimized. In other words, the tarp width, which is generally equal to the drum axial length, is commensurate with the longer dimension of the compartment. For many vehicles, this can mean that the tarp deploys from one lateral side of the compartment to the other opposite side. Such a device is disclosed in U.S. Pat. No. 6,595,594 Royer incorporated herein by reference. Further, these systems are often used on containers having width restrictions imposed by government or the environment in which the container or truck will be used. Because the leading edge of the tarp is so long, such systems are often prone to uneven deployment and winding.

Use of a single drive cable offset from the centerline of the drum can lead to uneven deployment and winding of the scroll upon the drum causing fouling and uneven wear.

In some tarp mechanisms, the retraction and rewinding of the tarp on a drum is effected by reversing the direction of the driving motor. This can result in loosening the tension of the tarp, resulting in uneven travel of the tarp, folds and creases that interfere with the orderly rewinding. In other prior art embodiments, two separate motors, one for deployment, the other for retraction are used as disclosed in Pettersen U.S. Pat. No. 5,354,113. The tension of the tarp is maintained by using the non-driving motor as a brake.

In order to enhance the seal formed between the tarp and the edges of the compartment, the tarp must be kept taut having tight contact with the compartment edges. In prior devices, this places significant forces on the tarp and winding mechanisms, leading to increased wear.

Some truck or container configurations provide limited space for installing tarp deployment and retraction hardware. Also, it is desirable that those mechanisms avoid interfering with the loading and unloading of the container.

The main drawbacks of the prior art deployment and retraction mechanisms are their complexity, bulkiness, and weight that render them impractical in the harsh environment in which dump trucks and trailers operate.

The instant invention results from attempts to maintain the tautness of the tarp, equalize the amount of force necessary to pull it over the entire length of its deployment, and minimize the required power and size or the driving mechanisms, and prevent overwinding.

### SUMMARY

The principal and secondary objects of the invention are to provide an improved automated scrolling tarp deployment and retraction system such as can be used to temporarily cover open-topped cargo containers.

These and other objects are achieved by a scrolling tarp deploying and retracting mechanism where the actuation cable slidingly engages the leading edge of the tarp scroll.

In some embodiments in a scroll deployment mechanism, wherein a leading edge of a scroll is repeatedly extended and retracted across a structure having a pair of substantially parallel upper lateral edges; there is provided an improvement which comprises: a cable driven by a motor, said cable slidingly engaging said leading edge; and, wherein movement of said cable causes said movement of said pull-rod.

In some embodiments said improvement further comprises a substantially rigid pull-rod secured to said leading edge. In some embodiments said cable slidingly engages a first pulley mounted to said pull-rod. In some embodiments said first pulley is located at a first end of said pull-rod and wherein said improvement further comprises a second pulley located at a second opposite end of said pull-rod. In some embodiments said first pulley is mounted to said pull-rod so that it can rotate in at least two angular dimensions. In some embodiments said scroll is wound upon a drum having a first end slidingly contacting a first one of said lateral edges. In some embodiments said improvement further comprises a track commensurate with said lateral edge and wherein said first end drum interlockingly engages and runs along said track, thereby inhibiting rotation of said first end of said drum. In some embodiments said means for inhibiting comprise a roller pin contacting an underside of said track. In some embodiments said pull-rod comprises a load deflector. In some embodiments said pull-rod comprises a first slider at an end of said pull-rod; said slider being shaped and dimensioned to form a lever as it passes over a distal edge of said compartment. In some embodiments said cable is repeatedly wound in a single run upon a conically shaped spool. In some embodiments said cable is wound upon a spool configured to progressively vary a length of said cable taken up with each turn of the spool.

In some embodiments said scroll includes an oblong region extending on a medial section of said scroll substantially parallel to said leading edge; wherein said region is secured to said drum; and, wherein a lateral edge of said scroll remains unsecured to said drum.

In some embodiments said improvement further comprises means for stiffening the pliability of said tarp lateral to said region. In some embodiments said means for stiffening comprise a resilient member secured to said region and extending laterally beyond said region toward said lateral edge. In some embodiments said improvement further comprises means for sensing a tension of said cable, and means for switching off a winding motor in response to said sensing means detecting that said tension is above or below a specified range. In some embodiments said sensing means comprise a spring-biased pulley gauge. In some embodiments there is an absence of any pulleys or cable runs located below the vertical level of said proximal and distal rims and inboard of said proximal and distal walls. In some embodiments said pull-rod extends over a distal edge of said structure when fully deployed. In some embodiments said improvement further comprises a resilient, gas-filled bumper oriented to impart a return force upon said pull-rod during initiation of a retraction action. In some embodiments said scroll comprises a cargo compartment cover.

In some embodiments there is provided a deployable and self-retracting structure for covering an area which comprises: a sheet of pliable material, commensurate with said area, said sheet having a leading edge; a mechanism, for unfurling under tension said sheet over said area, including a pliable cable having a first end wound upon a spool and a second fixed end; and wherein said cable has a medial portion slidingly engaging said leading edge; whereby a winding of said spool causes sliding movement of said cable with respect to said leading edge and thereby causes unfurling motion of said sheet.

In some embodiments said leading edge is secured to a substantially rigid pull-rod. In some embodiments said pull-rod is substantially hollow defining an internal channel and said cable extends through said channel. In some embodiments a first pulley slidingly engaging said cable is located at a first end of said pull-rod and a second pulley slidingly engaging said cable is located at a second end of said pull-rod. In some embodiments said cable is movingly secured to said pull-rod through a pulley mechanism. In some embodiments said pull-rod comprises: a first pulley located near a first end of said pull-rod; a second pulley spaced apart from said first pulley said first and second pulleys being engaged by a common length of said cable.

In some embodiments in a scroll control mechanism, wherein a scroll is wound up on a drum and is unwound against the tension of a spring secured to an axle, and the leading edge of the scroll is pulled by a flexible cable taken up by a spool driven by a motor or a hand-crank, there is provided an improvement which comprises: said scroll having front, back and lateral edges, and a width dimension and a length dimension; said drum having a first axial dimension commensurate with said width dimension of said scroll; said scroll including an oblong region extending on a medial section of said scroll substantially parallel to said front edge and spaced a distance from said lateral edges; and, wherein said region is secured to said drum; and, wherein said lateral edges are not directly secured to said drum.

In some embodiments said region is spaced substantially equidistantly from said back and front edges. In some embodiments said region forms a vaulted portion extending toward said drum while said scroll is fully deployed. In some embodiments the improvement further comprises an intermediate pliable tongue connecting said region to said drum.

### BRIEF DESCRIPTION OF THE DRAWING

FIG. 1 is an illustrative perspective view of a tarp cover system deploying over a cargo compartment.

FIG. 2 is an illustrative perspective and partial view of the left side end of the tarp winding drum in a fully deployed configuration.

FIG. 3 is a diagrammatical cross-sectional front elevational illustration of the tarping system of FIG. 2

FIG. 4 is a diagrammatical side elevational illustration of the tarp in the fully retracted configuration.

FIG. 5 is a diagrammatical side elevational illustration of the tarp in the fully deployed configuration.

FIG. 6 is a diagrammatical perspective operational illustration of the major components of the deployment system.

FIG. 7 is a diagrammatical cross-sectional view of the conical winding spool.

FIG. 8 is an illustrative perspective and partial view of the left side end of the pull-rod.

FIG. 9 is a diagrammatical side elevational illustration of the tarp deployment system showing the pull-rod approaching the distal rim of the compartment.

FIG. 10 is a diagrammatical side elevational illustration of the angularly deflecting pull-rod pulley as it closely approaches the distal rim of the compartment.

FIG. 11 is a diagrammatical side elevational illustration of the tarp tautening lever action of the pull-rod slider as it passes over the distal rim of the compartment.

FIG. 12 is a diagrammatical side elevational illustration of the tarp in the fully deployed configuration.

FIG. 13 is a diagrammatical perspective illustration of the tarp laid flat.

FIG. 14 is an illustrative perspective and partial view of the left side end of the tarp winding drum in a fully deployed configuration having a fabric tongue engaging the medial vaulted region of the tarp.

FIG. 15 is an illustrative perspective and partial view of the left side end of the compartment showing an alternate pulley arrangement to minimize vertical footprint.

### DESCRIPTION OF THE REFERRED EMBODIMENT

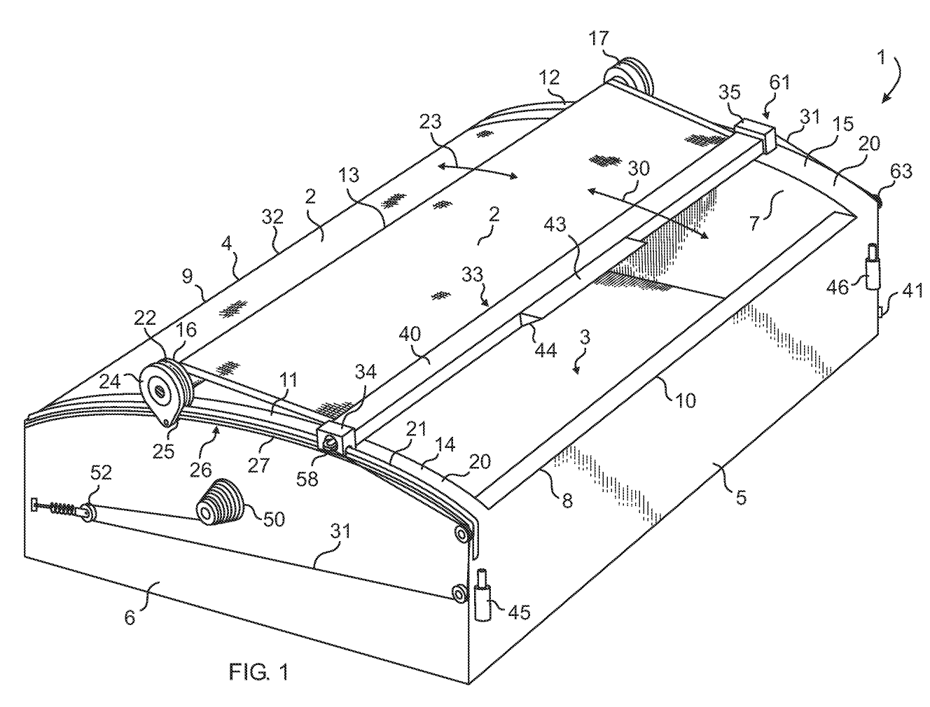

Referring now to the drawing, there is illustrated in FIGS. 1-3 a system 1 for deploying and retracting a scrolling tarp 2 made of a pliable, durable sheet material for covering loads in an open-topped cargo compartment 3. The system can typically be installed on side-deploying tarp systems that “roll-over” or otherwise operate in a sideways fashion (such as shown in Royer U.S. Pat. No. 6,595,594 incorporated herein by this reference) in reference to a typical container truck, rather than a front-to-back fashion. The terms “proximal”, “distal”, and “lateral” will be used in reference to the operation of the scroll deployment system rather than the container. In other words, for example, when fully deployed, the leading edge of the tarp will reach the distal rim of the container which can be located on a lateral side of a truck container.

The compartment 3 has a proximal end wall 4, distal end wall 5, and a pair of parallel lateral side walls 6,7. The four walls terminate in a substantially rectangular upper brim 8 having a proximal rim 9, a distal rim 10, and left and right lateral side rims 11,12. It is important to note that the left side rim 11 would typically be located at the front or rear of a vehicle.

The scroll 2 is unwound from a spring-loaded take-up drum 13 translatively spanning the container from side rim 11 to side rim 12. The scroll is secured to the drum along an elongated medial region described in greater detail below. In this way, the scroll 2 is wound upon the drum 13 from opposite directions to form a pair of interleaved spirals as the drum translates from a medial deployed location between the proximal and distal rims, to retracted location near the proximal rim.

Each of the lateral side rims 11,12 has a convex rounded, smooth upper surface 20 forming parallel curved tracks 14,15, although flat tracks may also be used. A pair of end wheels 16,17 are located at the ends of the drum 13 and rotatively ride upon curved tracks. An elongated longitudinal guide ridge 21 extends upwardly from the upper surface of left side track 14 which engages a corresponding circumferential groove 22 in the left side drum wheel 16.

Lateral to at least one of the drum end wheels 16,17 is a substantially non-rotating end structure 24 which forms a cam having a pin roller 25 which rotatively bears against the undersurface 26 of a longitudinal ledge 27 formed by a laterally extended edge of the track. The ledge conveniently allows for fastening the guide ridge 21 to the track from below. The cam structure is secured to an axle 28 to which the drum is rotatively mounted. A coil spring 29 having a first end 36 secured to the drum 13 and a second end 37 secured to the axle 28, biases rotation of the drum with respect to the axle. This structure allows the entire drum to move or translate 30 proximally or distally as the drum takes up and lets out the tarp 2 under the pull of a drive cable 31. This movement alternately winds and unwinds the spring. The drum wheels can freely rotate upon the guide and track.

A first proximal edge 32 of the scroll 2 is secured to the proximal rim 9 of the compartment 3. The opposite free or leading edge 33 of the scroll is secured to an oblong rigid hollow pull-rod 40 spanning the compartment from side rim to side rim. A pair of low friction, sliders 34,35 are located at the opposite lateral ends of the pull-rod and slidingly bear against the curved tracks 14,15 allowing the pull-rod to move proximally under the pull of the drive cable 31, or distally as the drum 13 takes up the scroll by force of the coil spring.

During a deployment action, the pull-rod 40 and thus the leading edge 33 of the scroll 2 traverses across the top opening of the compartment under the pull of a pliable drive cable 31, anchored at one end 41 near the distal right corner of the compartment, and taken up at an opposite end by a spool 50 driven by an electrical motor, preferably bi-directional, or alternately by a hand-crank. The leading edge of the pull-rod is adapted to carry a load deflector 43 device having an angled surface 44 which allows the pull-rod to climb over and/or push away interfering load elements from the path of the pull-rod.

As shown in FIG. 4, viewed in elevation from the left side, the scroll 2 is in the fully retracted configuration, wound upon the drum 13 to form a pair of interleaved spirals 18,19. The drum and pull-rod 40 rest near the proximal rim 9 of the container.

In FIG. 5 the scroll 2 is in the fully deployed configuration. The drum 13 has traversed to a medial position substantially equidistant between the proximal rim 9 and the distal rim 10. The pull-rod 40 has gone past the distal rim so that the scroll closely contacts the entire brim of the compartment top opening, thereby sealing it.

In the deployed configuration, the pull-rod 40 has also depressed a pair of upwardly biased, bumpers 45,46 which facilitate return of the pull-rod over the edge of the distal rim 10 at the initiation of a retraction action during which the scroll 2 retracts under the pull of the torsion spring located within the drum 13 as described above. The bumpers help the pull-rod lift over the lip of the distal rim. Each bumper is preferably a gas-filled cylinder and piston, shock-absorber-type mechanism. Alternately, the bumpers can be spring-loaded. However, gas-filled mechanisms are preferred due to the more linear resistance to compression than that provided by most spring mechanisms.

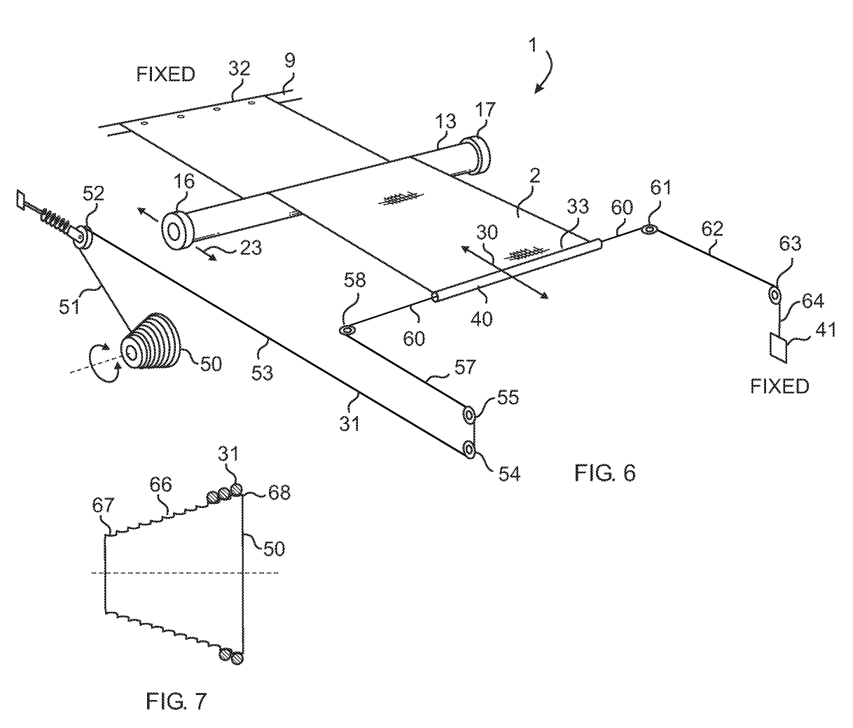

FIG. 6-7 shows a diagrammatic representation of the system 1 for driving the scroll mechanism. The cable 31 extends from the bidirectional cable winding spool 50 proximally along a first run 51 to a spring-loaded, tension-gauged pulley 52 described in greater detail below. From the tension-gauging pulley the cable extends distally along a second run 53 to engage a pair of pulleys 54,55 located near the distal wall of the compartment. The vertical run between the pulley pair allows the pull-rod to be pulled a vertical distance down the distal wall so that the scroll contacts the distal rim. From the pair of pulleys 54,55 the cable extends proximally along a third run 57 to a fourth pulley 58 located inside the left side slider on the left end of the pull-rod 40. The cable then extends laterally along a fourth run 60 through the hollow pull-rod to an opposite lateral end where it engages a fifth pulley 61 near the right slider. The cable then extends distally along a fifth run 62 to sixth pulley 63 and on a seventh vertical run 64 to the anchorment 41 located near the distal, right corner of the compartment. In this way, the pull-rod 40 translates 30 across the open top of the compartment at roughly twice the speed that the drum 13 translates 23.

In order to form a tighter seal between the lateral edges of the tarp and the brim of the container, greater force is applied to the tarp to stretch it taut. For a motor of a given power rating, the greater force is achieved by a spool 50 having a substantially conical shape providing a single conically spiral channel 66 (such as shown in Royer U.S. Pat. No. 6,595,594) having a shorter diameter 67 at one end and a wider diameter 68 at the opposite end. Movement of the cable 31 during the initial part of the deployment cycle can be rapid and relatively little torque is required by the motor. Consequently the cable is taken up on the spool where it has a relatively large diameter 68. Toward the end of the deployment cycle, where the spring in the drum provides a stronger resistive force, and a tight seal of the tarp to the rim is desired, the cable is taken up by that part of the spool having a smaller diameter 67 where lesser torque is required by the motor for a given tension on the cable. Also, by providing a single spiral channel, there is greater predictability for the exact amount of cable taken up or given out for any given revolution of the spool.

It should be noted that the far end of the cable need not be fixed but rather can be wound upon a second motorized spool located on the opposite side of the container.

The use of a conical spool is useful in a system which affixes the cable or cables to the pull-rod. Thus the pull-rod pulleys can be replaced with fixed cable anchors thereby eliminating the moving engagement of the cable with the pull-rod. This results in two separate cable lengths used on opposite lateral sides of the compartment. It should be noted that in this can lead to uneven winding of the drum unless the tension on the cables kept even.

It is important to note that in the preferred exemplary embodiment the cable 31 runs through and slidingly engages the pull-rod 40 attached to the leading, free edge 33 of the scroll 2. By using a single cable, the tension on both ends of the pull-rod remains substantially constant. Further, any minor inconsistencies in the winding of the cable onto the spool is automatically adjusted out by slight movement of the cable through the pull-rod.

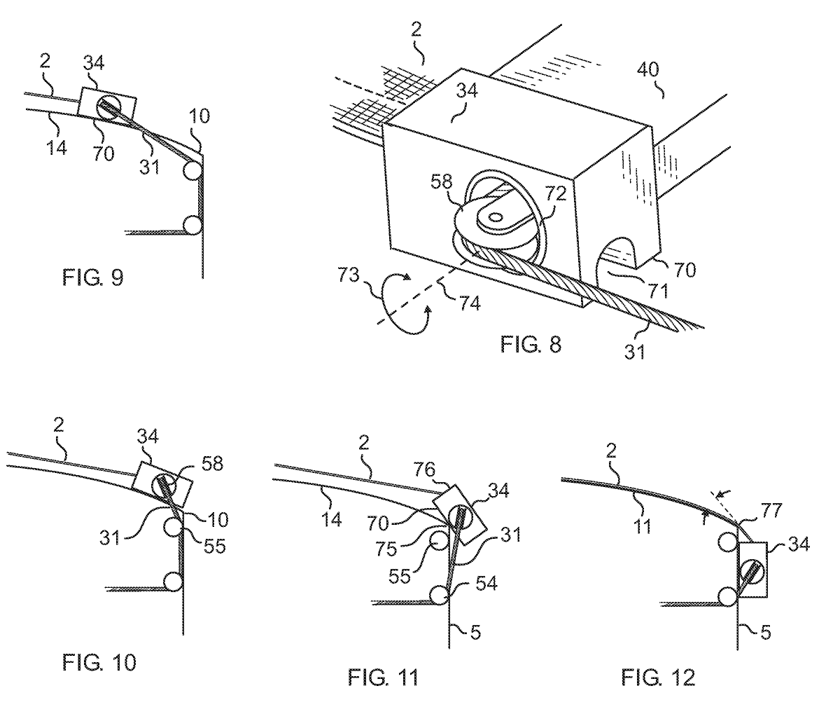

Referring now to FIGS. 1 and 8, as described above, the pull-rod 40 is secured to the leading edge of the scroll 2. The pull-rod terminates at its left end in a left side slider 34 having a low-friction bottom surface 70 contoured with a groove 71 to intimately and slidingly engage the ridge 21 and track 14 on the left side rim 11 of the compartment 3.

The left end pulley 58 is rotatively mounted to the slider 34 housing so that it moves in two angular dimensions, thus having two degrees of freedom. In other words, in addition to rotating as a standard pulley does in response to the cable 31 passing over it, each pull-rod pulley is also rotatively mounted to the pull-rod by a bearing structure 72 which allows rotation 73 about an axis 74 substantially parallel with the long dimension of the pull-rod. In this way, the pulley can track with the cable as its incident angle changes with respect to the pull-rod. In yet other words, each pull-rod pulley can be said to have a first rotation axis which rotates upon an second axis orthogonal to the first rotation axis. The pulley 61 mounted to the slider 35 at the right end of the pull-rod 40 is a similarly configured.

As shown in FIGS. 9-12, the pull-rod pulleys and the length of the slider bottom surface in the direction of movement facilitate a tarp tautening lever action as the pull-rod sliders pass over the edge of the distal rim when the scroll is being deployed.

In FIG. 9, the pull-rod slider 34 secured to the leading edge of the scroll 2 is proceeding along the track 14 on the side rim of the compartment toward the distal rim 10 under the pull of the cable 31. The bottom surface 70 of the slider is in full contact with the track 14.

In FIG. 10, as the slider 34 approaches the distal rim 10, the orientation of the cable 31 begins deflecting toward the upper pulley 55 and thus the pull-rod pulley 58 rotates within the slider housing accordingly.

In FIG. 11, as the slider 34 passes over the edge 75 of the distal rim, the proximal part of the slider bottom surface 70 lifts off of the track 14 and a proximal portion 76 of the slider raises upward acting as the end of a lever having a fulcrum at the distal rim edge 75. This causes a tautening of the scroll 2. Tautness is maintained as the slider proceeds down the distal wall 5 of the compartment. It is important to note that the cable 31 is allowed to lift off and disengage from the upper pulley 55 so that the bottom pulley 54 takes over pulling the pull-rod downward. In this way the pull-rod can be said to make a downward turn over the brim of the container.

In FIG. 12 the scroll 2 has reached its fully deployed configuration tightly contacting and conforming to the brim of the compartment including the side rim 11. The pull-rod slider 34 has proceeded far enough down the distal wall 5 of the compartment so that the tarp forms a bend 77 over the edge of the distal rim.

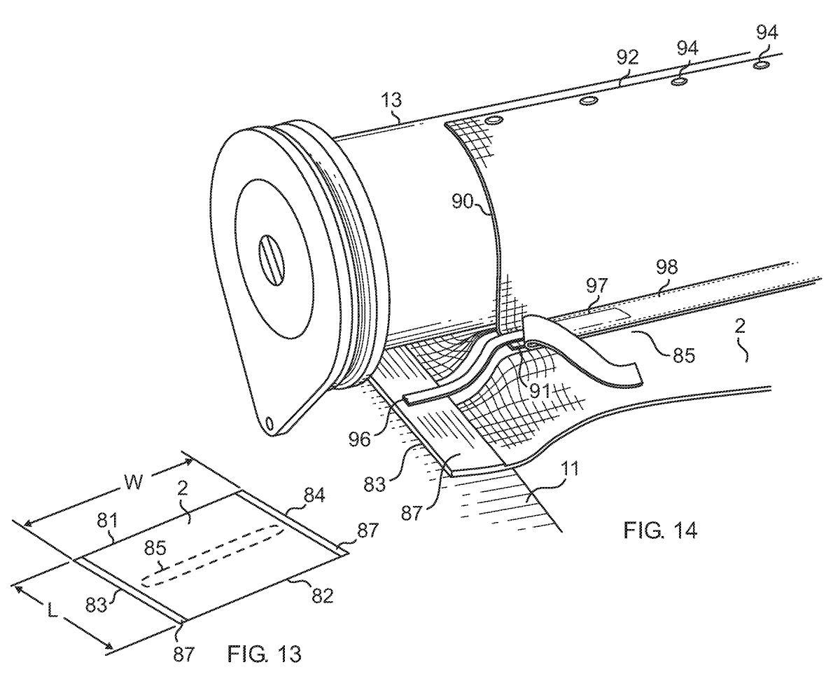

Referring now to FIG. 13-14, in order to form a tighter seal between the lateral edges of the tarp and the lateral rims of the compartment, the scroll 2 is secured to the drum 13 along an elongated medial region described but spaced inwardly from the lateral edges of the tarp.

In FIG. 13 the laid flat scroll 2 has a substantially rectangular shape having proximal edge 81, distal edge 82 and left and right lateral edges 83,84, and a width dimension W and a length dimension L. The width dimension is substantially commensurate with the axial length dimension of the drum 13. The scroll includes an oblong region 85 extending laterally on a medial section of the scroll, spaced apart from the lateral edges, and substantially parallel to the distal edge 82. This region is secured to the outer wall of the drum leaving the lateral edges 83,84 free. This allows the lateral edges to separate away from the drum and closely bear against the lateral side rims of the compartment when the scroll is fully deployed. In other words, when fully deployed, the lateral edges of the tarp drop down away from the drum and onto the side rims. The medial region of the tarp then attains a vaulted configuration 86 to engage the drum. It should be noted that the lateral edges of the tarp can be made to have thickened portions 87 in order to ruggedize the edges to accommodate the additional tension stresses of tightly engaging the track.

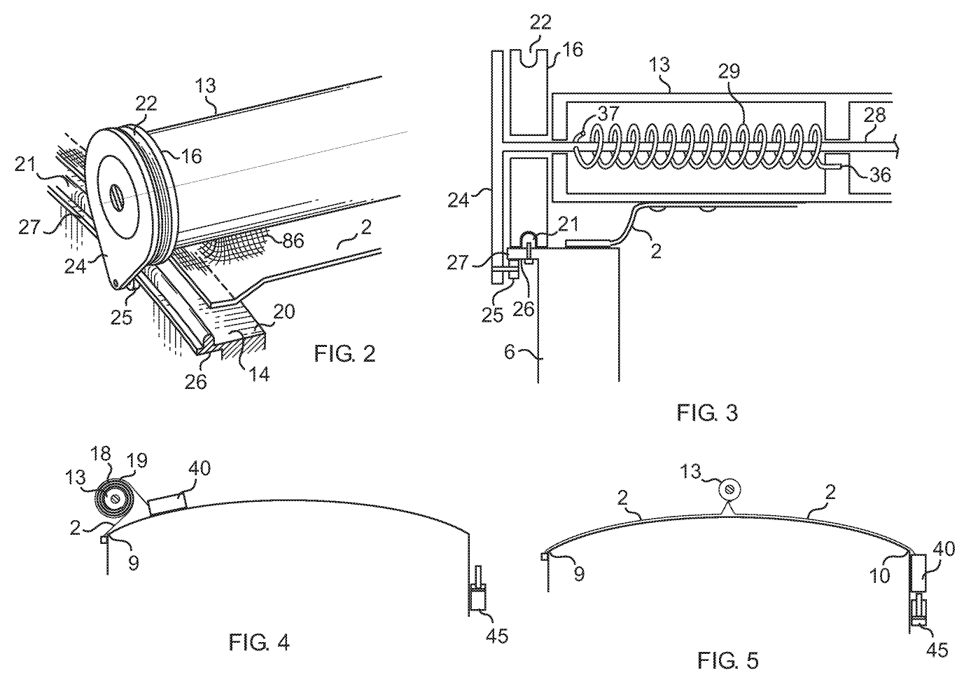

Although the tarp can be secured directly to the bottom of the drum as shown in FIG. 2, more preferably, as shown in FIG. 14, a tongue of material 90 is sewn to the medial region 85 along a first edge 91 and secured to the drum 13 along an opposite parallel edge 92 to provide easy access to fasteners 94.

As further shown in FIG. 14, a semi-rigid stiffening batten 96, made from a thin strip of durable strong resilient material such as metal or plastic, is optionally sewn into a pocket 97 formed between a fabric strip 98 and the medial region. The batten extends laterally from the lateral end of the vaulted zone toward the lateral edge of the tarp. A second batten can be similarly secured to the right side of the tarp. The battens function to ensure proper initial winding of the tarp in the vaulted region onto the drum during the beginning of a retraction operation by preventing folding.

Referring now to FIGS. 1 and 6, there is shown a spring-loaded, tension-gauged pulley 52 connected to an automatic motor winding electronic cutoff switch. The switch is calibrated to actuate and turn off the winding motor whenever the tension of the cable falls outside a specified range during retraction or deployment actions. Turning off the motor prevents the cable from falling off spool when a stuck pull-rod prevents a retraction action. It also can prevent overtightening or motor burnout when the pull-rod gets stuck during a deployment action or after the tarp is fully deployed and the operator continues to press the deployment button. By keeping the motor operating within a specified tension range, less expensive motors can be used and their useful lifetime extended. It is understood that the cut-off switch can be implemented using other means for detecting whether the cable tension has fallen outside a specified range.

By running the cabling along outer surfaces of the compartment and through the hollow pull-rod, the cable is protected by avoiding interference with the material forming the container load, such as dirt or rocks.

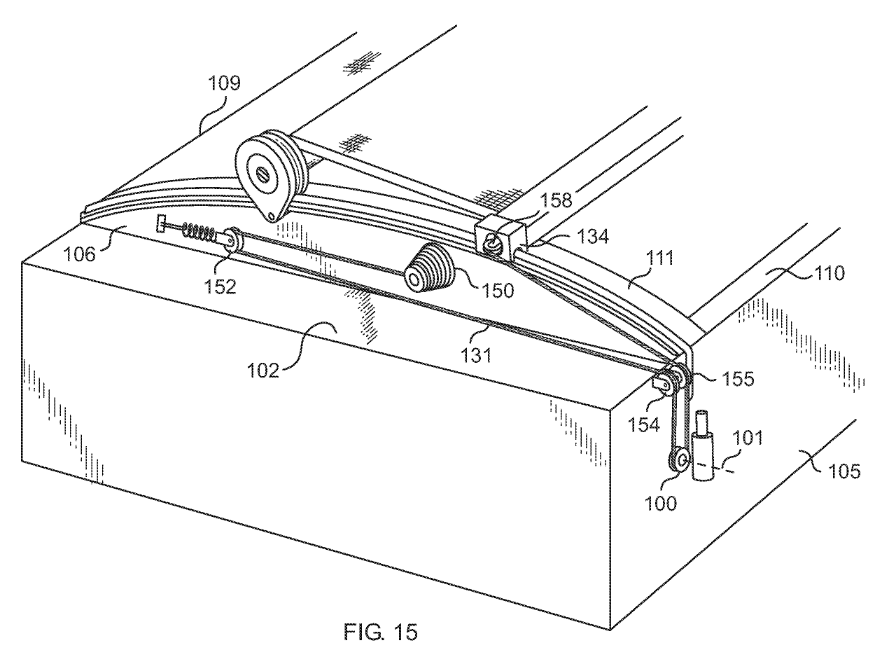

FIG. 15 shows an alternate pulley arrangement of the system which helps to minimize the vertical footprint of the winding mechanisms. Specifically, an additional outboard pulley 100 is located between the pulley pair 154,155 (corresponding to pulleys 54 and 55 in the embodiment of FIG. 6) which are located between the tension gauge pulley 152 and the pull-rod pulley 158. The additional pulley 100 is orienting to have a rotation axis 101 substantially orthogonal to the distal wall 105. In this way, the drive spool 150 and the tension gauge pulley 152 can be located so that they essentially reside above the vertical level 102 of the proximal rim 109 and distal rim 110. In other words, the winding hardware can be placed entirely along the side end wall 106 within the dome of the curved side rim 111 in absence of any pulleys or cable runs located below the vertical level of the proximal and distal rims and inboard of the proximal and distal walls. In this way, the pulleys and cabling can be located so that the system does not interfere with the operation of a tail gate or other structure formed into the side end wall of the compartment. It should be noted that the location of the pull-rod pulley 158 in the slider 134 housing should be selected to allow for adequate clearance over the pulleys mounted on the distal wall. The pulleys at the opposite side end can be similarly configured.

The above described system using the translating drum allows the tension range of the coil spring to be limited, allowing the use of a much smaller one than would normally be required, and allowing a potential reduction of the maximum loads on the spring and other components of the device. This in turn allows for a less rugged and more light-weight design leading to greater fuel economy. Further, a reduction in load ranges can lead to a longer life span of other mechanical parts. Since the improved arrangement applies less retracting force to the drum, a relatively smaller motor may be used to deploy and retract the tarp cover.

While the preferred embodiment of the invention has been described, modifications can be made and other embodiments may be devised without departing from the spirit of the invention and the scope of the appended claims.

What is claimed is:

1. In a scroll deployment mechanism, wherein a leading edge of a scroll is repeatedly extended and: retracted across a structure having a pair of substantially parallel upper lateral edges; an improvement which comprises:
a cable driven by a motor, said cable slidingly engaging said leading edge; and,
wherein movement of said cable causes said movement of said pull-rod.

2. The improvement of claim 1, wherein said improvement further comprises a substantially rigid pull-rod secured to said leading edge.

3. The improvement of claim 2, wherein said cable slidingly engages a first pulley mounted to said pull-rod.

4. The improvement of claim 3, wherein said first pulley is located at a first end of said pull-rod and wherein said improvement further comprises a second pulley located at a second opposite end of said pull-rod.

5. The improvement of claim 3, wherein said first pulley is mounted to said pull-rod so that it can rotate in at least two angular dimensions.

6. The improvement of claim 1, wherein said scroll is wound upon a drum having a first end slidingly contacting a first one of said lateral edges.

7. The improvement of claim 6, wherein said improvement further comprises a track commensurate with said lateral edge and wherein said first end drum interlockingly engages and runs along said track, thereby inhibiting rotation of said first end of said drum.

9. The improvement of claim 8, wherein said means for inhibiting comprise a roller pin contacting an underside of said track.

10. The improvement of claim 2, wherein said pull-rod comprises a load deflector.

11. The improvement of claim 2, wherein said pull-rod comprises a first slider at an end of said pull-rod; said slider being shaped and dimensioned to form a lever as it passes over a distal edge of said compartment.

12. The improvement of claim 2, wherein said cable is repeatedly wound in a single run upon a conically shaped spool.

13. The improvement of claim 2, wherein said cable is wound upon a spool configured to progressively vary a length of said cable taken up with each turn of the spool.

14. The improvement of claim 2, wherein said scroll includes an oblong region extending on a medial section of said scroll substantially parallel to said leading edge;
wherein said region is secured to said drum; and,
wherein a lateral edge of said scroll remains unsecured to said drum.

15. The improvement of claim 14, which further comprises means for stiffening the pliability of said tarp lateral to said region.

16. The improvement of claim 15, wherein said means for stiffening comprise a resilient member secured to said region and extending laterally beyond said region toward said lateral edge.

17. The improvement of claim 1, which further comprises means for sensing a tension of said cable, and means for switching off a winding motor in response to said sensing means detecting that said tension is above or below a specified range.

18. The improvement of claim 17, wherein said sensing means comprise a spring-biased pulley gauge.

19. The improvement of claim 1, where there is an absence of any pulleys or cable runs located below the vertical level of said proximal and distal rims and inboard of said proximal and distal walls.

20. The improvement of claim 2, wherein said pull-rod extends over a distal edge of said structure when fully deployed.

21. The improvement of claim 20, which further comprises a resilient, gas-filled bumper oriented to impart a return force upon said pull-rod during initiation of a retraction action.

22. The improvement of claim 1, wherein said scroll comprises a cargo compartment cover.

23. A deployable and self-retracting structure for covering an area which comprises:
a sheet of pliable material, commensurate with said area, said sheet having a leading edge;
a mechanism, for unfurling under tension said sheet over said area, including a pliable cable having a first end wound upon a spool and a second fixed end; and
wherein said cable has a medial portion slidingly engaging said leading edge;
whereby a winding of said spool causes sliding movement of said cable with respect to said leading edge and thereby causes unfurling motion of said sheet.

24. The structure of claim 23, wherein said leading edge is secured to a substantially rigid pull-rod.

25. The structure of claim 24, wherein said cable is movingly secured to said pull-rod through a pulley mechanism.

26. In a scroll control mechanism, wherein a scroll is wound up on a drum and is unwound against the tension of a spring secured to an axle, and the leading edge of the scroll is pulled by a flexible cable taken up by a spool driven by a motor or a hand-crank, an improvement which comprises:
said scroll having front, back and lateral edges, and a width dimension and a length dimension;
said drum having a first axial dimension commensurate with said width dimension of said scroll;
said scroll including an oblong region extending on a medial section of said scroll substantially parallel to said front edge and spaced a distance from said lateral edges; and,
wherein said region is secured to said drum; and,
wherein said lateral edges are not directly secured to said drum.

27. The improvement of claim 26, wherein said region is spaced substantially equidistantly from said back and front edges.

28. The improvement of claim 26, wherein said region forms a vaulted portion extending toward said drum while said scroll is fully deployed.

29. The improvement of claim 26, which further comprises an intermediate pliable tongue connecting said region to said drum.
